(19) United States
(12) Patent Application Publication
(10) Pub. No.: US 2006/0267473 A1
(43) Pub. Date: Nov. 30, 2006

(54) Colour cathode ray tube with essentially flat screen

(76) Inventors: Carlo Tulli, Rome (IT); Pedro Eugenio Cosma, Rome (IT); Paolo Ginesti, Gavignano (IT); Alessio Masi, Ceccano (IT)

Correspondence Address: THOMSON LICENSING INC., PATENT OPERATIONS, PO BOX 5312, PRINCETON, NJ, 08543-5312, US

(21) Appl. No.: 10/542,744

(22) PCT Filed: Dec. 23, 2003
(86) PCT No.: PCT/FR03/50209

§ 371 Date: Aug. 9, 2006

(30) Foreign Application Priority Data
Jan. 20, 2003 (IT) MI2003A000076

(51) Int. Cl. H01J 29/80

(52) U.S. Cl. 313/407

(57) ABSTRACT

Cathode-ray tube comprising a frame/colour selection mask assembly, in which the free end of the skirt of the mask is constrained by lugs integral with the frame, in such a way as to minimize the nuisance movements of the skirt of the mask under the influence of vibrations generated by the environment of the tube.

The present invention relates to a colour cathode-ray tube having a substantially flat screen, and more precisely to a frame/colour selection mask assembly with which such a tube is equipped.

The invention finds its application in any type of tube comprising a colour selection mask, and is more especially adapted to tubes whose mask is made by stamping and is held in place inside the tube by a rigid frame to which it is secured.

A conventional colour cathode-ray tube is composed of an evacuated glass envelope. Inside the envelope, the tube comprises a colour selection mask situated at a precise distance from the glass faceplate of the tube, on which faceplate are deposited red, green and blue phosphor grids so as to form a screen. An electron gun disposed inside the tube, in its rear part, generates three electron beams directed towards for the faceplate. An electromagnetic deflection device, generally disposed outside the tube and close to the electron gun has the function of deflecting the electron beams so as to make them scan the surface of the panel on which the phosphor grids are disposed. Under the influence of three electron beams each corresponding to a specified primary colour, the phosphor grids allow the reproduction of colour images on the screen, the mask allowing each specified beam to illuminate only the phosphor of the corresponding colour.

The colour selection mask must be disposed and held during the operation of the tube in a precise position inside the tube. The mask holding functions are carried out by virtue of a generally very rigid rectangular metal frame to which the mask is conventionally welded.

The frame/mask assembly is mounted in the faceplate of the tube by virtue of suspension means welded to the frame and cooperating with studs inserted into the glass constituting the faceplate of the tube.

The colour selection mask is made from a very thin metal foil and comprises a surface, the so-called effective surface, pierced with apertures, the said apertures being made by chemical etching and generally disposed in vertical columns; the effective surface is surrounded by an unperforated peripheral border; a skirt, generally made by stamping, runs along the edge of the assembly extending in a direction substantially perpendicular to the effective surface. The mask is secured to the frame by spot welding at points of the skirt. The current trend is for tubes whose faceplate is every flatter, evolving towards completely flat faceplates with inner and outer surfaces defined by very large radius of curvature.

Generally, the surface of the mask must follow the shape of the inner part of the faceplate of the tube, in such a way that their curvature is substantially identical. The colour selection mask of a conventional tube has a surface defined by horizontal and vertical profiles whose radii of curvature are small, of the order of 1 or 2 metres in the central zone; this curved surface can be represented by a complex polynomial expression and the small value of the radii of curvature ensures the mechanical rigidity of the surface of the mask.

In the case of a tube whose screen looks flat, the radii of curvature defining the surface of the mask are also large values. In this case, the surface of the mask facing the screen of the tube is substantially flat and this results in low mechanical rigidity which renders the said mask very sensitive to external vibrations, induced for example by loudspeakers of the television equipped with the said tube; the mask then begins to vibrate, giving rise to modifications of its distance from the screen and thus causing discoloration of the image formed on the said screen.

Various devices have been developed for avoiding the vibrations of the mask by attempting to boost the rigidity of the surface of the mask without proving completely satisfactory.

Patent U.S. Pat. No. 6,111,348 proposes a solution consisting in boosting the rigidity of the surface of the mask by creating vertical striations on the said surface.

Patent U.S. Pat. No. 4,645,968 discloses a colour cathode-ray tube frame/mask structure in which the skirt of the mask is welded to the support frame, which frame comprises parts in relief coming between the welds in contact with the skirt of the mask. This structure partially dampens the vibrations of the mask, but this improvement is inadequate for tubes of large dimensions, exhibiting a very flat mask surface.

The invention was concerned with the movements of the skirt of the mask and it was remarked that these skirt movements, produced by the vibrations caused in the environment of the tube, had negative effects on the behaviour of the mask and that it was necessary for the said movements to be avoided or minimized to the maximum.

Accordingly, the colour cathode-ray tube according to the invention comprises:
a substantially rectangular faceplate on the inner surface of which is deposited a luminescent screen, the said faceplate being practically perpendicular to the longitudinal axis Z of the tube,
a colour selection mask disposed facing the luminescent screen, the said mask comprising a perforated surface substantially perpendicular to the longitudinal axis Z and a peripheral skirt bent in a direction substantially parallel to the longitudinal axis Z,
a substantially rectangular frame comprising a pair of long sides and a pair of short sides, each side of the frame exhibiting a flange substantially parallel to the longitudinal axis Z, the peripheral skirt of the mask being welded to the said flange at several points

characterized in that the frame comprises lugs disposed on the flange of the side in contact with the skirt of the mask, the said lugs at least partially overlapping the free end of the said skirt.

The principals of the invention as well as its advantages will be better understood with the aid of the following description and of the drawings, among which:

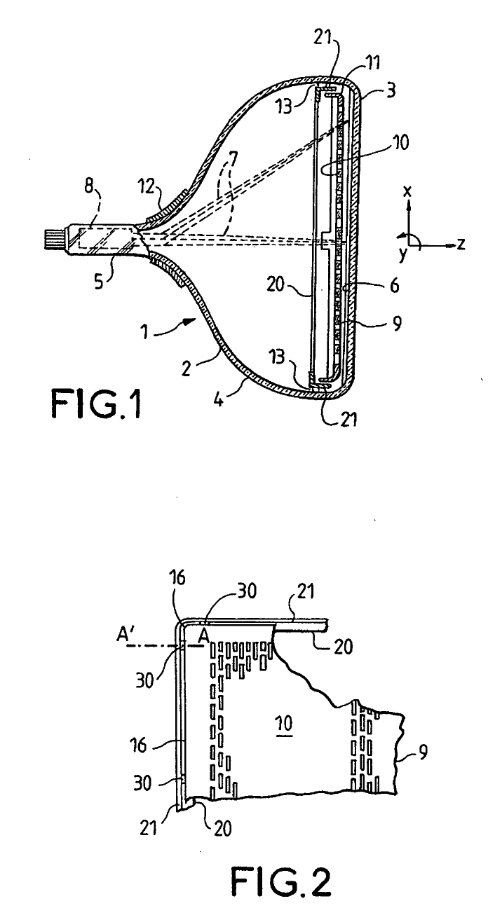

FIG. 1 illustrates a section of a cathode-ray tube with colour selection mask along the longitudinal axis

FIG. 2 shows a frame/mask assembly according to the invention in a partial view from above

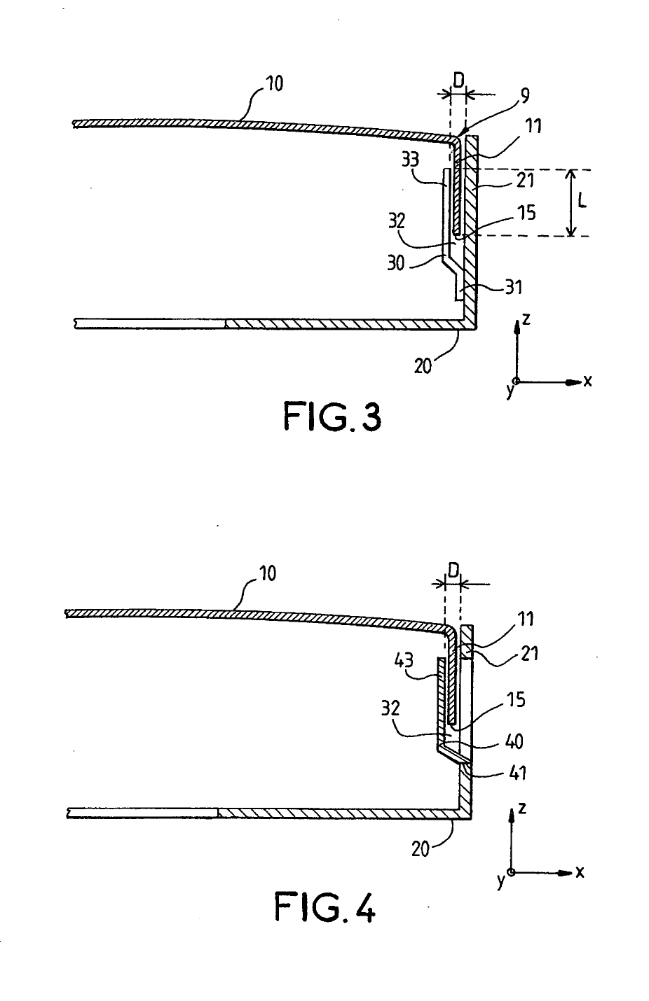

FIG. 3 is a cross-sectional view of the embodiment of FIG. 2 on the axis A′A

FIG. 4 illustrates through a cross-sectional view another embodiment on the axis A′A

FIG. 1 shows a cathode-ray tube 1 composed of an evacuated envelope 2 comprising a substantially rectangular faceplate 3 and a funnel-shaped rear part 4 terminating in a cylindrical neck 5. The faceplate is defined from a horizontal axis X, parallel to its largest dimension, and from a vertical axis Y, parallel to its smallest dimension; the axes X and Y cross at the centre of the faceplate and are perpendicular to the principal longitudinal axis Z which passes through the centre of the cylindrical neck 5 and through the centre of the faceplate 3.

On the inner part of the faceplate 3 is deposited a screen 6 of luminescent materials, these being excited by the scanning of the electron beams 7 emanating from an electron gun 8 disposed in the neck of the tube.

The scanning of the electron beams is carried out by a magnetic deflection device 12 disposed on the neck of the tube.

Inside the glass envelope is disposed a colour selection mask 9 comprising a perforated surface 10, substantially parallel to the surface of the screen 6, and a skirt 11, bent in a direction substantially parallel to the longitudinal axis Z.

A frame 20, of L-shaped section, is mounted inside the glass envelope in such a way as to position the mask at a precise distance from the luminescent screen. The frame comprises a flange 21 which extends practically in a direction parallel to the axis Z. The skirt 11 of the mask is disposed inside the frame and spot welded to the flange 21.

The frame/mask assembly is held in place in the glass envelope by virtue of studs 13 included in the glass envelope cooperating with springs secured to the frame.

FIGS. 2 and 3 illustrate an embodiment of the invention by showing a partial view from above and a cross-sectional view of the frame/mask assembly.

The mask comprises a perforated active surface 10 surrounded by a skirt 11 bent along a direction substantially parallel to the Z axis. The skirt terminates in a free edge 15. The skirt is inserted inside the frame 20 and welded to the flange 21 at several points 16, generally disposed at the corners of the mask and in the middle of the parallel sides of the said rectangular mask. Lugs 30 are secured to the flange of the frame at various points of the latter; these lugs are made for example from metal plates welded at one of their ends 31 to the flange 21 and bent in such a way as to contrive a space 32 between the frame and a surface 33 of the lug facing the flange 21, which space is intended to be partially occupied by the skirt 11 of the mask. In this way, the free edge 15 of the mask is partially overlapped by the lug 30; at the location where the said lug is disposed, the skirt of the mask is constrained in the free space 32, thereby limiting the movement of the free part of the skirt.

In a tube with substantially flat faceplate, using a mask with a thickness of around 200 μm, and having a screen diagonal of 68 cm, the space 32 between the flange of the frame is chosen preferably at a value D of around 1 mm. Experience shows that depending on the size of the tube, the thickness of the mask and the principal frequency of vibration to be damped, the space D is preferably chosen between 3 and 8 times the thickness of the mask. The mechanical constraints exerted by the lugs will cause an increase in the resonant frequency of the mask and bring it to a value greater than 100 Hz rendering its effects practically invisible to the eye of the observer.

It has been observed moreover that the effects of the lugs were maximized when the width of overlap L of the skirt by the lug, in the direction of the Z axis was at least 50% of the length of the skirt along this same direction.

The lugs 30 may be disposed on a pair of parallel sides of the frame or on the four sides of the said frame. In the case where a plurality of lugs is disposed on parallel sides of the frame, it has been discovered that lugs ought preferably to be disposed between the points where the frame is welded to the mask.

The plurality of lugs disposed on a side of the frame may advantageously be replaced with a single lug overlapping more than half the length of the free end 15 of the mask, extending along the side of the said frame. Thus for the tube with diagonal equal to 68 cm when a single lug according to the invention is disposed on each side of the frame, which lug overlaps 90% of the length of the free end of the mask in the direction parallel to the side of the frame, the resonant frequency of the frame/mask assembly is brought to value greater than 150 Hz, rendering the movements of the mask invisible to the eye of the observer. This embodiment of the invention allows faster manufacture of the frame and offers results which are substantially equivalent to the use of a plurality of lugs per side of the frame.

The lugs 30, as illustrated in the embodiments of FIGS. 2 and 3, may consist of add-on components welded to the sides of the frame.

The lugs may also be made from the material constituting the flange itself. Accordingly, another embodiment of the invention is illustrated by FIG. 4 in the form of a lug 40. The lug 40 is made from the material constituting the flange 21; for example, when the lug has a substantially rectangular shape, three sides of the lug are formed by cutting out the material of the frame, one side 41 remaining integral with the latter. The material cut out is then pushed back towards the inside of the frame in such a way as to form a metal panel 43 substantially parallel to the flange 21 and situated at a distant D from the latter, in such a way as to contrive a space 32 between the lug and the flange of the frame.

1. Colour cathode-ray tube comprising:
a substantially rectangular faceplate on the inner surface of which is deposited a luminescent screen, the said faceplate being practically perpendicular to the longitudinal axis Z of the tube,
a colour selection mask disposed facing the luminescent screen, the said mask comprising a perforated surface substantially perpendicular to the longitudinal axis Z and a peripheral skirt bent in a direction substantially parallel to the longitudinal axis Z,
a substantially rectangular frame comprising a pair of long sides and a pair of short sides, each side of the frame exhibiting a flange substantially parallel to the longitudinal axis Z, the peripheral skirt of the mask being welded to the said flange at several points
wherein the frame comprises lugs disposed on the flange of the side in contact with the skirt of the mask, the said lugs at least partially overlapping the free end of the said skirt.

2. Cathode-ray tube according to claim 1, wherein opposite sides of the frame comprise a lug extending over at least 90% of the length of the free end of the mask in the direction parallel to the sides of the frame to which the lug is secured.

3. Cathode-ray tube according to claim 1, wherein lugs extend in the direction of the longitudinal axis Z in such a way as to overlap at least 50% of the length of the skirt along this same direction.

4. Cathode-ray tube according to claim 1, wherein lugs are made by partial cutting out of the material of the frame.

5. Cathode-ray tube according to claim 1 wherein the space D contrived between a lug and the surface of the flange is between 3 and 8 times the thickness of the mask.
